(19) United States
(12) Patent Application Publication
(10) Pub. No.: US 2022/0363598 A1
(43) Pub. Date: Nov. 17, 2022

(54) Concrete Product and Methods of Preparing the Same

(71) Applicant: S3 Concrete Technologies, Inc., Marietta, GA (US)

(72) Inventor: Jason S. Adams, Marietta, GA (US)

(73) Assignee: S3 Concrete Technologies, Inc., Marietta, GA (US)

(21) Appl. No.: 17/711,493

(22) Filed: Apr. 1, 2022

Related U.S. Application Data
(60) Provisional application No. 63/201,851, filed on May 14, 2021.

(51) Int. Cl. C04B 14/02; C04B 14/38

(52) U.S. Cl. CPC C04B 14/022; C04B 14/38; C04B 2111/00172

(57) ABSTRACT

A concrete product set by pouring a concrete slurry includes a) a concrete mixture; b) a graphene admixture; and c) at least one reinforcing fiber selected from the group of fibers. As the poured concrete slurry cures, the poured slurry hardens into a composite material product, and the composite material is embedded with graphene. In another exemplary embodiment, the present invention is directed to a process for preparing a concrete product. The process comprises the steps of a) preparing a concrete slurry with integral graphene; b) pouring the concrete slurry; c) allowing the concrete slurry to cure; and d) optionally spray-applying graphene and/or optional colloidal silica as a curing technique. In another exemplary embodiment, the present invention is directed to the product itself; namely, a concrete product with fibers and embedded graphene.

### RELATED APPLICATION

This application claims the benefit of provisional application Ser. No. 63/201,851, filed on May 14, 2021, the entire contents of which are incorporated herein.

### FIELD

The present disclosure generally relates to concrete construction processes and to the formation of concrete products. More particularly, the present disclosure is generally directed to a system for and method of preparing and pouring a concrete slurry for the formation of concrete products.

### BACKGROUND

Concrete products, such as concrete slabs (floor slabs, foundation slabs), concrete rafts, concrete pillars and columns, etc., are usually composed of unreinforced or reinforced concrete. The level of reinforcement generally is dictated by at least the intended use, the exposure to the elements, the load, and the loading intensities, amongst various other factors. Reinforcement also is used to control cracking or fracturing, which is common throughout the useful life of a concrete product.

Various attempts have been made in the field to minimize the need for reinforcement. Unsuccessful solutions have been conceived to vary the composition of the concrete mixture, and/or to vary the methods of preparing the concrete mixture into a concrete slurry, and/or to vary the ballast material used in forming the final concrete product. These possible solutions; however, usually require a concrete formulation comprising expansive admixtures with the hope of countering the shrinkage of the concrete and the loss of water. In these solutions it is difficult to determine the proper amount of expansive admixtures required to counter the shrinkage.

The use of such unsuccessful solutions usually gives rise to unpredictable results; in particular, results requiring concrete-producing entities to employ one or more solutions to mitigate the risk of concrete slab failure. This adds unnecessary complexity and unforeseen consequences, as is described in greater detail herein. It is therefore desirable to overcome the deficiencies of and provide for improvements in the state of the prior art.

Improved methods, process, and systems in the formation of concrete products are discussed. As used herein, any reference to an object of the present invention should be understood to refer to solutions and advantages of the present invention, which flow from its conception and reduction to practice, and not to any a priori or prior art conception. A better understanding of the principles and details of the present invention will be evident from the following description.

### SUMMARY

Exemplary embodiments are directed to a system for, and a method of, forming concrete products like concrete slabs and rafts and molded concrete products, based on a uniquely prepared concrete mixture and/or a unique curing technique. Exemplary embodiments also are generally directed to a process for the formation of concrete products that is more efficient and effective, and that reduces the carbon footprint, energy consumption, and environmental costs of preparing, placing, and producing concrete products.

In one exemplary embodiment, a concrete product may be set by pouring a concrete slurry. In an exemplary embodiment, the poured concrete slurry comprises a) a concrete mixture; b) a graphene admixture; and c) at least one fiber selected from a group of fibers consisting of steel fibers, helix fibers, basalt fibers, polyvinyl alcohol (PVA) fibers, carbon fibers, and synthetic fibers. As the poured concrete slurry cures, the poured concrete slurry hardens into a composite material defining capillary structures and that takes the form of a concrete product of hardened aggregate and cement. The capillary structures of the concrete product at least in part fill with graphene, as the graphene is dispersed in the poured slurry to embed along and partially fill the capillary structures throughout the hardened aggregate and cement. The graphene provide stiffness and strength to, and prevent over-drying, shrinkage, and cracking of, the concrete product.

In another exemplary embodiment, the graphene admixture comprises dispersed nanometer-sized graphene in a liquid phase carrier wherein the graphene are buckled, and the graphene are about 1.10±0.20 nm thick with a lattice constant of about 0.27 nm×0.41 nm. The concrete mixture comprises aggregate, cement, and water, wherein the concrete mixture is defined by a water to cement ratio of between about 0.400 to about 0.450. If present, the at least one fiber selected from a group of fibers represents between about 0.25 percent (%) by volume to about 0.50% by volume of the poured concrete slurry, or more specifically between about 0.20% by volume to about 0.50% by volume of the poured concrete slurry.

In another exemplary embodiment, the concrete product is set by pouring a concrete slurry and then applying a curing technique to the poured and set concrete slurry. In an exemplary embodiment, the curing technique may comprise spray-applying a secondary application of the dispersed graphene and/or a first application of colloidal silica and/or a first application of a graphene variety not otherwise already used (in an exemplary embodiment where no colloidal silica is integral to the concrete slurry prior to the spray-applying step, for example) (or in an exemplary embodiment where no graphene of one type—such as graphene, graphene oxide, or r-GO—is integral to the concrete slurry prior to the spray-applying step, for example) onto the poured and set concrete slurry. The mixture used for the spray application is defined as having between about 10.0 grams to 1,000.0 grams of graphene per gallon of liquid carrier. The spray-applied mixture can be applied using pump sprayers, walk-behind electric-powered “turf” sprayers, and the like, and includes all manner of spraying a liquid solution onto a surface.

In another exemplary embodiment, the present invention is directed to a process for preparing a concrete product. In an exemplary embodiment, the process comprises the steps of a) preparing a concrete slurry comprising i) a concrete mixture; ii) a graphene admixture; and iii) at least one fiber selected from a group of fibers consisting of steel fibers, helix fibers, basalt fibers, PVA fibers, carbon fibers, and synthetic fibers, b) pouring the concrete slurry; and c) allowing the concrete slurry to cure such that the cement and aggregate structure of the concrete product have the nanometer-sized graphene embedded therein.

In an exemplary embodiment, the preparing step comprises preparing the concrete slurry with a graphene admixture, wherein the graphene admixture is formed from sheared graphite powder, and adding the graphene admixture to the concrete slurry in ranges of between about 0.01% to about 0.10% by weight of cement. The preparing step additionally comprises preparing the concrete slurry for pouring with dosages of steel fibers as the at least one fiber selected from a group of fibers of between about 33.0 pounds per cubic yard (lbs./cuyd) to about 66.0 lbs./cuyd. The preparing step additionally comprises preparing the concrete slurry for pouring with dosages of macro synthetic fibers as the at least one fiber selected from a group of fibers of between about 3.0 lbs./cuyd to about 7.5 lbs./cuyd. The preparing step additional comprises preparing the concrete slurry for pouring with dosages of helix fibers as the at least one fiber selected from a group of fibers of between about 3.0 lbs./cuyd to about 35.0 lbs./cuyd.

In another exemplary embodiment, the process additionally comprises the step of spray-applying a secondary graphene application, a first application of colloidal silica, and/or a first application of a graphene variety not otherwise already used (in an exemplary embodiment where no colloidal silica is integral to the concrete slurry prior to the spray-applying step) (or in an exemplary embodiment where no graphene of one type, such as graphene, graphene oxide, or r-GO, is integral to the concrete slurry prior to the spray-applying step, for example), a secondary colloidal silica application, and/or the secondary graphene and colloidal silica composite onto the poured concrete slurry onto the poured concrete slurry to facilitate curing thereof. The mixture used for the spray-applying step is defined as having between about 10.0 grams to 1,000.0 grams of graphene per gallon of liquid carrier. In an exemplary embodiment, the spray-applying step comprises spray applying the graphene application onto the poured concrete slurry subsequent to removal of a trowel machine, and prior to cement in the poured concrete slurry being completely set, or subsequent to cement in the poured concrete slurry being completely set.

In another exemplary embodiment, a concrete product is provided. The concrete product is set from a concrete slurry, the poured concrete slurry comprising a concrete mixture, a graphene admixture, and at least one fiber selected from a group of fibers consisting of steel fibers, helix fibers, basalt fibers, PVA fibers, carbon fibers, and synthetic fibers, the concrete product comprising hardened aggregate and cement embedded with sheared graphite powder, whereby the dispersed graphene particulates provide stiffness and strength, and prevent over-drying, shrinkage, and cracking of the concrete product.

### BRIEF DESCRIPTION OF THE DRAWINGS

FIG. 1 is a perspective view of an exemplary concrete slab.

FIG. 2 is a magnified perspective view of a cut-away portion of the concrete slab of FIG. 1.

FIG. 3 is a flow diagram showing the steps of a first illustrative embodiment of a method for placing a concrete product.

FIG. 4 is a flow diagram showing the steps of a second illustrative embodiment of a method for placing a concrete product.

FIG. 5 is a flow diagram showing the steps of a third illustrative embodiment of a method for placing a concrete product.

FIG. 6 is a flow diagram showing the steps of a fourth illustrative embodiment of a method for placing a concrete product.

FIG. 7 is a flow diagram showing the steps of a fifth illustrative embodiment of a method for placing a concrete product.

FIG. 8 is a flow diagram showing the steps of a sixth illustrative embodiment of a method for placing a concrete product.

FIG. 9 is a flow diagram showing the steps of a seventh illustrative embodiment of a method for placing a concrete product.

FIG. 10 is a flow diagram showing the steps of an eighth illustrative embodiment of a method for placing a concrete product.

FIG. 11 is a flow diagram showing the steps of a ninth illustrative embodiment of a method for placing a concrete product.

FIG. 12 is a flow diagram showing the steps of a tenth illustrative embodiment of a method for placing a concrete product.

FIG. 13 is a perspective view of an exemplary fiberless concrete product.

### DETAILED DESCRIPTION

For a further understanding of the nature, function, and objects of the present invention, reference should now be made to the following detailed description. While detailed descriptions of the preferred embodiments are provided herein, as well as the best mode of carrying out and employing the present invention, it is to be understood that the present invention may be embodied in various forms. Specific details disclosed herein are not to be interpreted as limiting but rather as a basis for the claims and as a representative basis for teaching one skilled in the art to employ the present invention in virtually any appropriately detailed system, structure, or manner.

For purposes of this disclosure, percent (%) by weight refers to the aggregate weight of the particles in comparison to the final weight of cement in a final concrete product.

For purposes of this disclosure, graphene refers to the broad category of single-layer allotropes of carbon, which are arranged in a two-dimensional hexagonal, or honeycomb lattice. As is well known in the art, carbon is capable of forming many allotropes-structurally different forms of the same element-due to valency, for example. Well-known forms of carbon include diamond and graphite.

Graphene—in the broadest sense—is a portmanteau of “graphite” and the suffix “-ene”, reflecting the fact that the graphite allotrope of carbon essentially consists of stacked graphene layers. The IUPAC (International Union for Pure and Applied Chemistry) recommends use of the term “graphite” for the three-dimensional material, and “graphene” only when the reactions, structural relations, or other properties of the graphite's individual layers are being referred to. Another definition—of “isolated or free-standing graphene”—teaches that the layer(s) (up to 10 layers together, for example) be sufficiently isolated from its environment, but would include layer(s) suspended or transferred to silicon dioxide or silicon carbide via exfoliation, sonication, or chemical vapor deposition, etc., for example.

In any sense, the individual layers or stacks of layers of graphite of any type—graphite, graphite oxide, or graphite with other functional groups—may be known simply as graphene in the art. In each layer, the carbon atoms are arranged in a hexagonal, or honeycomb lattice with a bond length of about 0.142 nm, and a distance between planes of about 0.335 nm; however, these variables may slightly vary depending on the specific chemical structure of the graphene. Atoms in the plane are bonded covalently, with only three of the four potential bonding sites satisfied. Bonding between layers is via weak van der Waals bonds, which allow layers of graphite to be easily separated, or to slip past each other.

Graphite oxide, formerly called graphitic oxide or graphitic acid, is a compound of carbon, oxygen, and hydrogen in variable ratios, obtained by treating graphite with strong oxidizers and acids for the resolving of extra metals, for example. The maximally oxidized bulk product is a yellow solid with C:O ratio between 2.1 and 2.9, that retains the layer structure of graphite, but with a much larger and irregular spacing. The bulk material spontaneously disperses in basic solutions or can be dispersed by sonication in polar solvents to yield monomolecular sheets known as graphene oxide, for example. The “graphene” obtained by reduction of graphene oxide (GO)-reduced graphene oxide or r-GO herein—still has many chemical and side-structural groups that distinguish them from pure graphene. Strictly speaking “oxide” is an incorrect but historically established name. Besides oxygen epoxide groups (bridging oxygen atoms), other functional side groups for graphene include: carbonyl (C═O); hydroxyl (—OH); phenol, for graphite oxides prepared using sulphuric acid (e.g., Hummer's method), to name a few.

With regard to GO reduction, monolayers of r-GO with few functional or side groups, or defects, are readily available for commercial use. The rapid heating of GO along with exfoliation or sonication, for example, is known to yield highly dispersed carbon powder with a few percent of graphene in composition. Similarly, dispersed r-GO suspensions can be synthesized in water via hydrothermal dehydration methods, without the use of any surfactants. As such, graphene as used herein refers to the broad category of single-layer allotropes of carbon as described above and herein.

Embodiments and aspects of the present disclosure provide a system for, and method of, preparing and pouring a concrete slurry for the formation of concrete products, which are not susceptible to the limitations and deficiencies of the prior art. The inventive concepts described herein allow for the formation, in certain non-limiting embodiments, of concrete slabs and rafts, based on the addition of a chemical admixture when preparing the concrete slurry. In other non-limiting embodiments, the inventive concepts described herein allow for the formation of concrete slabs and rafts based on the application of a chemical treatment to a poured concrete slurry, which in some instances facilitates curing of the poured concrete. In other non-limiting embodiments, the inventive concepts described herein allow for the formation of a concrete product based on the synergistic combination of a specifically prepared concrete slurry with a curing technique.

The inventive concepts described herein also allow for a decreased need for and a decreased use of traditional reinforcements such as rebar and/or mattings. This allows for efficiencies in time, labor, and resources, and allows for a streamlining and simplifying of the process for forming and maintaining a concrete product.

A first exemplary embodiment provides a system for, and method of, preparing and pouring a concrete slurry for the formation of concrete products, wherein micro- and/or nano-particles, particulates, carbon-chains and/or fibers are paired with a durable and flexible blend of aggregates, pastes, and admixtures, to provide a mass of substantially impermeable concrete exhibiting exceptional tensile strength and durability for the heaviest loads and equipment.

A second exemplary embodiment provides a system for, and method of, forming a concrete product via a concrete slurry and/or curing technique, wherein the concrete slurry leverages graphene in optional combination with fibers (steel ASTM 820 fibers, helix fibers, basalt fibers, polyvinyl alcohol fibers, carbon fibers, and/or other macro synthetic ASTM C1116 fibers, for example, wherein ASTM is defined as American Society for Testing and Materials and its consensus standards, grades, and certifications, as of 6 Aug. 2020) to create an improved concrete mass. The graphene is used as an admixture for the concrete slurry and/or sprayed onto the surface of the poured concrete slurry as a “cure” soon after or right after the trowel machine is removed.

The graphene works to fill a capillary structure in the concrete to reduce internal tensile forces and/or to provide stiffness and strength, which drastically reduces the likelihood of shrinking and cracking of the concrete. Spraying the surface of the poured concrete slurry with the graphene at the appropriate time and dosage as described herein has been found by the inventor to be similar to a 28-day wet cure. In an exemplary embodiment, open capillaries, or open capillary structures, are filled with nanometer-sized graphene, which reduce or substantially eliminate moisture loss by plugging the pores of the open capillary structures. Further, the concrete structure defining the capillaries is embedded with nanometer-sized graphene, which are defined by stiffness and strength due to the presence of a two-dimensional graphene backbone. It is possible that the graphene may overlap to create an interwoven layer structure that distributes load. The inventor has also found that this process is not temporary, and is instead a permanent solution.

At this high-level non-limiting example, the use of the dispersed graphene as an admixture and/or spray works to prevent shrink cracking and moisture loss and provides a reinforcement effect to the concrete product. The dispersed graphene may be derived from graphite, also known as graphitic or graphitic acid, which may be obtained by treating graphite with strong oxidizers. Graphite demonstrates considerable variations of properties depending on the degree of oxidation and synthesis method used. Regardless of how it is derived, the graphene spontaneously disperses in basic solutions or can be dispersed by sonication, for example, in polar solvents to yield the graphene.

Graphite oxide and the derived graphene oxide may be hydrophilic and easily hydrated when exposed to water in liquid or gas phase, resulting in a distinct increase of the inter-planar distance (up to about 1.2 nm in its saturated state). Additional water may be incorporated into the interlayer space between monolayers of graphene oxide due to high-pressure induced effects. The hydration state of graphene oxide in liquid water corresponds to insertion of about 2-3 water monolayers, for example. Complete removal of water from graphene oxide is known to be difficult as direct heating at 60-80° C. commonly results in partial decomposition and degradation of the chemical structure. Conversely, graphite and the derived graphene may have negligible solubility in water.

A third exemplary embodiment provides a process for placing a concrete slab on a substrate for industrial and commercial applications. The slab is characterized by having superior abrasion-resistance and higher than normal resistance to the effects of aggressive water and chemical attack, such as salt, when compared to traditional concrete composite materials. The slab also provides a highly dense, highly accurate, and planar concrete surface with limited internal macro-reinforcements and a thinner cross section than a conventional concrete slab of the same strength.

For this particular embodiment, the process comprises: (1) preparing a concrete slurry with a water to cement ratio of between about 0.400 to about 0.450, with steel fibers or macro synthetic fibers (helix, basalt, PVA, carbon or other macro synthetic fibers, for example), or a combination of these fibers, (2) preparing the concrete slurry with graphene, integral thereto, (3) performing a “spray-apply” step using graphene, and (4) providing reaction and performance enhancing chemicals to the slurry or to the curing/to-be finished product. The overall process comprises establishing a highly accurate, and well compacted subbase preparation as a foundation in preparation for placement of the concrete.

A fourth exemplary embodiment provides a method comprising the step of using steel fibers to mitigate shrinkage cracks in the concrete. Fibers help mitigate plastic and drying shrinkage by arresting the movement of the concrete slab and distributing any shrinkage across the entire slab and fiber network area by means of micro cracking, i.e., when shrinkage occurs the fibers engage and redistribute the shrinkage. This holds true for both steel and macro-synthetic fibers, as described in greater detail herein.

This step may be one step in a series of steps making up an exemplary embodiment. As is described in greater detail herein, shrinkage cracks occur either as early plastic shrinkage, nucleating in the first 24 hours while the concrete has low strength, or nucleating as late cracks, due to the external restraint of the volume change during the drying shrinkage. As water is lost in the cement paste, shrinking places the aggregates in compression. Fine and discrete cracks nucleate and extend from the perimeter of the aggregates, and the numerous fine cracks continue to extend, while shrinkage increases over time and the cracks coalesce. As the concrete slab shrinks, the concrete slab shortens in all directions. The microcracks then combine at the location of the greatest strain and stress, where subsequently a crack will form.

For this particular embodiment, the step of using steel fibers to mitigate shrinkage cracks in the concrete allows for fibers to be randomly distributed throughout the concrete slab and can, with close spacing and good bonding, intercept the formation of cracks. Different types of steel fibers may be used for different applications. Some Type 2 steel fibers are sized to number about 9000.0 fibers per pound (lb.) and are used typically in dosages of about 33.0 lbs./cuyd (representing about 0.250% by volume of concrete) to about 66.0 lbs./cuyd (representing about 0.50% by volume of concrete). Some Type 1 steel fibers are sized and number about 2500.0 fibers per pound and may also be used.

A fifth exemplary embodiment provides a method comprising the step of using macro synthetic fibers to mitigate shrinkage cracks in concrete. This step may be one step in a series of steps making up an exemplary method of the present invention. The effect of the macro synthetic fibers is similar to the step of using steel fibers to mitigate shrinkage cracks in the concrete. However, the step of using macro synthetic fibers to mitigate shrinkage cracks in concrete also improves water retention and; therefore, assures a more complete hydration of the cement, and may also reduce plastic shrinkage more effectively than steel fibers in some circumstances. Further, the high fiber count associated with the step of using macro synthetic fibers intercepts the formation of microcracks and, therefore, reduces the formation of larger cracks. The macro synthetic fibers also may be added to the concrete in dosage rates of about 3.0 lbs./cuyd representing about 0.20% by volume of concrete to about 7.50 lbs./cuyd, representing about 0.50% by volume of concrete, or about 3.0 lbs./cuyd to about 35.0 lbs./cuyd if helix fibers.

A sixth exemplary embodiment provides a method comprising the step of using or adding graphene to the slurry. This step may be one step in a series of steps making up an exemplary method of the present invention.

With regard to the graphene oxide or graphene, an oxidation product of the compound carbon with or without oxygen and hydrogen in variable C:O ratios of between 2.1 and 2.9 may come made available in an aqueous solution. In its dry form, it essentially presents as a black powder or soot. The bulk oxidation-product, dispersed in solution or not, is defined as having graphene nanoplatelets—single layer and multi-layer graphene—in its composition with or without trace minerals like biochar and/or granular non-activated carbon.

The graphene, in comparison to graphite, have layers/stacked layers that are buckled, and the interlayer spacing is about two times larger (˜0.7 nm) than that of graphite. The graphene layers are about 1.10±0.20 nm thick and the graphene layers are spontaneously dispersed in a basic solution or mechanically dispersed by sonication in a polar solvent, as needed. Scanning tunneling microscopy shows the presence of local regions where oxygen atoms are arranged in a rectangular pattern with lattice constant of about 0.27 nm×0.41 nm. Graphene has unique surface properties, which make it a very good surfactant material stabilizing various colloidal systems.

For this particular embodiment, the dispersed graphene admixture is added to the concrete during the preparation phase in ranges of between about 0.01% to about 0.10% by weight of cement, depending on the concrete slurry design and the application.

A seventh exemplary embodiment provides a method comprising the step of using a spray-applied graphene as a curing technique. This step may be one step in a series of steps making up an exemplary method of the present invention. Graphene with particles sizes of about 0.5 nm in a liquid carrier are sprayed on a surface of the finished concrete slab after final set of the cement, or as described in greater detail herein.

The spray-applied graphene can be applied using a pump sprayer, a walk-behind electric-powered “turf” sprayer, and the like, as well as custom-made automated spraying machines. The entire surface of the slab is sprayed such that the nanometer-sized particles penetrate and fill the capillary structures and become embedded into the surrounding concrete structure. This process step of spray-applying graphene may occur after the concrete has been trowel finished and can be walked on without imprinting the surface.

An eighth exemplary embodiment provides a system for, and a method of, preparing and pouring a concrete slurry with graphene, as described herein, for the formation of concrete products, wherein a polycarboxylate ether-based superplasticizer admixture is paired with the cement mixture, graphene admixture, and/or the secondary spray-applied graphene, to provide an impermeable fiberless mass of concrete. With a relatively low dosage (0.15-0.30% by weight of cement, for example), a polycarboxylate ether-based superplasticizer allows water reduction due to its chemical structure, which enables good particle dispersion. Polycarboxylate ether-based superplasticizers are composed of a methoxy-polyethylene glycol copolymer (side-chain) grafted with methacrylic acid copolymer (main-chain). The carboxylate group—COO—Na+ dissociates in water, providing a negative charge along the polycarboxylate ether-based superplasticizer backbone. As a consequence of PCE adsorption, the zeta potential of the suspended particles changes, due to the adsorption of the COO-groups on the colloid surface. This displacement of the polymer on the particle surface provides the side chains the opportunity to exert repulsion forces, which disperse the particles of the suspension and help avoid friction.

A ninth exemplary embodiment provides a system for, and method of, forming a concrete product via a concrete slurry and/or curing technique, wherein the concrete slurry comprises colloidal silica and graphene in optional combination with steel and/or macro synthetic fibers to create a concrete product. The colloidal silica and graphene composite is used as an admixture and/or sprayed onto the surface of the poured concrete slurry soon after or right after the trowel machine is removed.

The colloidal silica works to fill the capillary structures with reactive nanometer-sized silica particles that react with the free lime to produce a stable gel structure of calcium silicate hydrate, which reduces or substantially eliminates moisture loss by plugging the pores of the capillary structures. At this high-level non-limiting example, the use of colloidal silica as an admixture and/or spray works with the internal cement molecule. Colloidal silica, which is included within the category of pozzolans, is a suspension of fine amorphous, nonporous, and typically spherical silica particles in a liquid phase. During curing and thereafter, the colloidal silica will react with free lime, increasing the density and structural strength of the solid structures formed. The increased density and long-term pozzolanic action ties up free lime, which limits the creation of channels and decreases the permeability in the concrete structure. Moreover, the resultant chemical and structural effect also helps keep contaminants and particles on the surface of the concrete.

A tenth exemplary embodiment provides a process comprising: (1) preparing a concrete slurry with a water to cement ratio of between about 0.400 to about 0.450, with steel fibers or macro synthetic fibers, or a combination of these fibers, (2) preparing the concrete slurry with colloidal silica and graphene, integral thereto, (3) performing a “spray-apply” step using colloidal silica, and (4) providing reaction and performance enhancing chemicals to the slurry or to the curing/to-be finished product. The overall process comprises establishing a highly accurate, and well compacted subbase preparation as a foundation in preparation for placement of the concrete.

An eleventh exemplary embodiment provides a method comprising the step of using or adding colloidal silica and graphene to the slurry. This step may be one step in a series of steps making up an exemplary method of the present invention. Amorphous nanometer-sized silica (SiO₂) in a particle size ranging from between about 3.0 nm to about 100.0 nm, or from between about 5.0 nm to about 100.0 nm, is in aqueous solution and is added to the concrete slurry along with the graphene admixture and the reaction enhancing and workability enhancing (rheology enhancing) admixtures, such as polycarboxylate. The silica will react with the free lime or calcium hydroxide (Ca(OH)₂) from the cement hydration to form a solid gel product called CSH, or calcium silicate hydrate (CaSiO₃+H₂O).

For this particular embodiment, as is shown in the following Formula 1: Ca(OH)₂+SiO₂ ó CaSiO₃+H₂O (1), the colloidal silica aqueous solution is added to the concrete during the preparation phase in ranges of between about 0.50% to about 10.0% by weight of cement, depending on the concrete slurry design and the application. The above described chemical reaction will consume some of the capillary water and will fill the pores with the hydration products CSH and, therefore, greatly reduce drying shrinkage.

A twelfth exemplary embodiment provides a method comprising the step of using a spray-applied colloidal silica and graphene as a curing technique. This step may be one step in a series of steps making up an exemplary method of the present invention. Amorphous colloidal silica with sizes of between about 3.0 nm to about 50.0 nm in an aqueous solution and/or graphene with sizes of about 0.5 nm is/are sprayed on a surface of the finished concrete slab after final set of the cement, or as described in greater detail herein.

The nanometer-sized silica penetrates up to about 3.0″ deep into the hardened concrete after between about 3.0 to about 6.0 hours after the final set of cement and react with the capillary pore water and available calcium hydroxide to form CSH, calcium silicate hydrate, as described herein. This also will seal the top of the concrete and prevent water from evaporating from the concrete mixture and thus enhance the cement hydration process.

A thirteenth exemplary embodiment provides a method of preparing a graphene and colloidal silica composite admixture comprising the step of adding graphite powder to a colloidal silica admixture, and either mechanically shearing the composite with a high-shear mixing device, and/or mechanically shearing the composite via probe sonication with an ultrasonic cavitation device, such that the resulting graphene are dispersed into the colloidal silica admixture. The resulting composite admixture may then be mixed into a concrete mixture as described herein.

A fourteenth exemplary embodiment provides a method of preparing a graphene and/or colloidal silica spray application and using it as specific chemical treatment for a poured concrete slurry, which may be prepared without graphene or colloidal silica, whereby the spray application facilitates curing of the poured concrete. This method can be used for the formation of any concrete product like a concrete slab or raft, or any molded concrete product, etc.

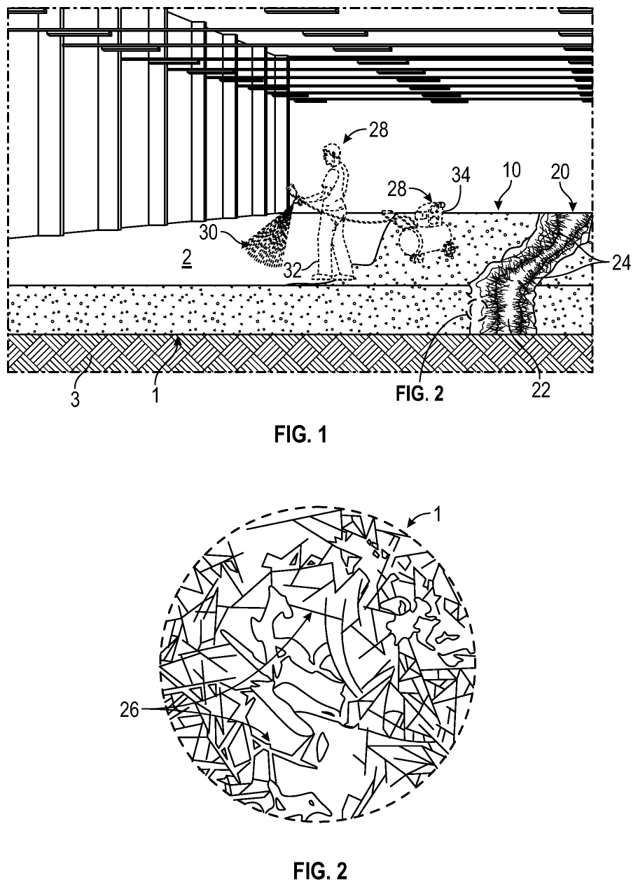

FIG. 1 shows a perspective view of an exemplary concrete slab 1. Concrete slab 1 of FIG. 1 is shown placed in warehouse-type setting according to an exemplary embodiment. Concrete slab 1 is placed on top of a leveled and compacted substrate 3 and is for industrial and commercial applications in this exemplary embodiment.

Concrete slab 1 is illustrated in partial cut-away form to show layers of internal composition and structure of the composite material. The first cut-away section 10 illustrates the sub-surface, below the curing/to-be finished exterior 2. The sub-surface of first cut-away section 10 is porous, unfinished and rough. The second cut-away section 20 illustrates concrete slab 1 having a crack 22 to expose the internal composition of the composite material of concrete slab 1. In particular, concrete slab 1 comprises hardened aggregate and cement as well as one or more of steel fibers and macro synthetic fibers 24. However, in other exemplary embodiments, concrete slab 1 may be made without such steel fibers and/or macro synthetic fibers. The hardened aggregate and cement, as well as steel fibers and macro synthetic fibers 24 if such fibers are included, at least in part define capillary structures 26 (best seen in FIG. 2) throughout concrete slab 1. In an exemplary embodiment, capillary structures 26 (FIG. 2) are filled with nanometer-sized graphene. The concrete structure defining capillary structures 26 also is embedded with nanometer-sized graphene. In another exemplary embodiment, if a colloidal silica admixture is used to prepare the concrete slurry, then capillary structures 26 (FIG. 2) also are filled with reactive nanometer-sized silica that react with free lime to produce a stable gel structure of calcium silicate hydrate within capillary structures 26.

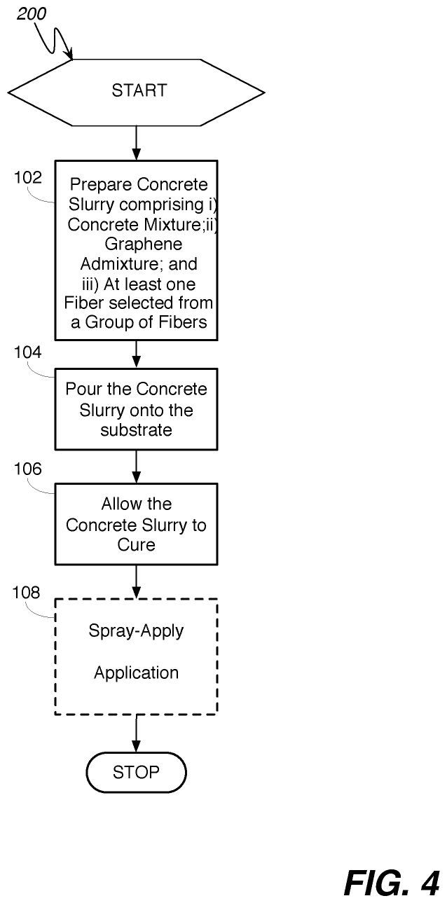

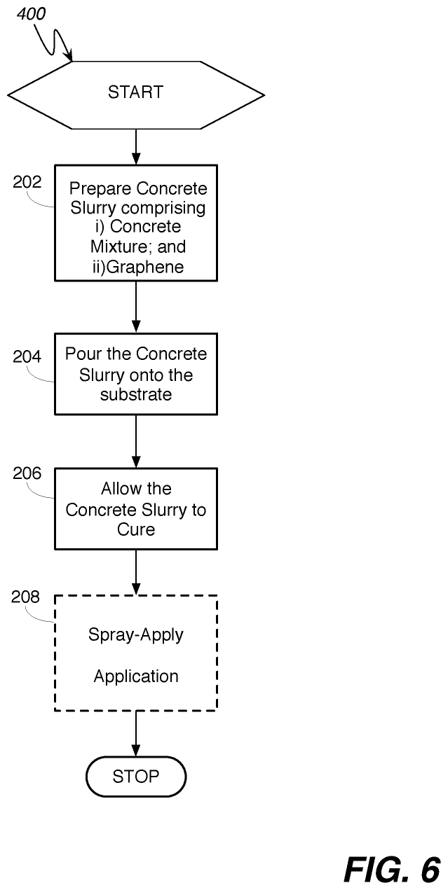

Concrete slab 1 is illustrated with an optional and exemplary spray-apply system 28. System 28 may also be used for spray-applying a secondary graphene 30 as described herein (see FIGS. 4 and 6) and/or spray-applying a first application of a graphene variety not otherwise already used in the concrete. System 28 comprises an optional human operator 32 using an exemplary embodiment of a spraying machine 34. System 28 optionally is used after a concrete slurry of the present invention is poured, trowel finished, and can be walked on by human operator 32, without imprinting the surface of hardening concrete slab 1. System 28 optionally sprays the entire surface of concrete slab 1 to saturation such that the nanometer-sized graphene in secondary or primary graphene spray 30 can penetrate capillary structures 26 and the surrounding concrete structure defining capillary structures 26 (it would be primary graphene spray 30, for example, in an exemplary embodiment where no graphene, such as graphene, graphene oxide, or r-GO, is integral to the concrete prior to primary graphene spray 30 being applied). In another exemplary embodiment, if colloidal silica is used to prepare secondary spray/primary spray 30, then the nanometer-sized colloidal silica in secondary/primary silica spray 30 also can penetrate capillary structures 26.

FIG. 2 is a magnified perspective view of crack 22 along second cut-away section 20 of the concrete slab 1 of FIG. 1. The magnified section of FIG. 1 illustrated in FIG. 2 shows a view of the intersection of the hardened aggregate and cement as well as steel fibers and macro synthetic fibers 24, if included, that at least in part define capillary structures 26 of concrete slab 1. In one exemplary embodiment, concrete slab 1 may comprise and benefit from joint cutting, and crack 22 may be situated along a line for a possible cut-joint or possible construction-joint, for example.

Joint cutting in an already-placed concrete slab, or joint making in a to-be-placed concrete slab, commonly is used to divide at least a portion of the width of the concrete slab into adjacent partitioned slabs, such that any shrinkage or contraction of the concrete is localized to the cut-line or joint and will thereby minimize such formations at other portions of the partitioned slab. Cut joints in concrete slab 1 may come in various forms, such as saw-cutting the slab at 5.0 meters (m) to 15.0 m intervals at full or partial depth, or full-depth construction joints at similar intervals. Certain regulatory agencies have guidelines recommending joints at about 14.0 feet (′) distances for a 6 inch (″) thick slab, and at about 17.0′ distances for an 8″ thick slab. That said, the graphene as an additive integral to concrete slab 1 in combination with joint cutting or a joint-making solution provides a synergistic benefit. The synergistic benefit means that joints safely and effectively can be placed at about 20.0 feet (′) distances for a 6 inch (″) thick slab, and at about 25.0′ distances for an 8″ thick slab, or at greater distances possible than without the inventive concepts described herein.

In other exemplary embodiments, concrete slab 1 may comprise and benefit from the use of a shrinkage-compensating concrete mix comprising a Type K cement incorporating a calcium sulfoaluminate additive, for example, to avoid the need for or to mitigate the quantity of joints in the slab. This Type K cement, which is one example of the broader field of expansive cements, is used in combination with rebar or steel fibers to help restrain the cement of concrete slab 1 as it expands. The expansive cement composite with integral silica and/graphene may require at least a 7-day wet cure to ensure that the designed expansion occurs.

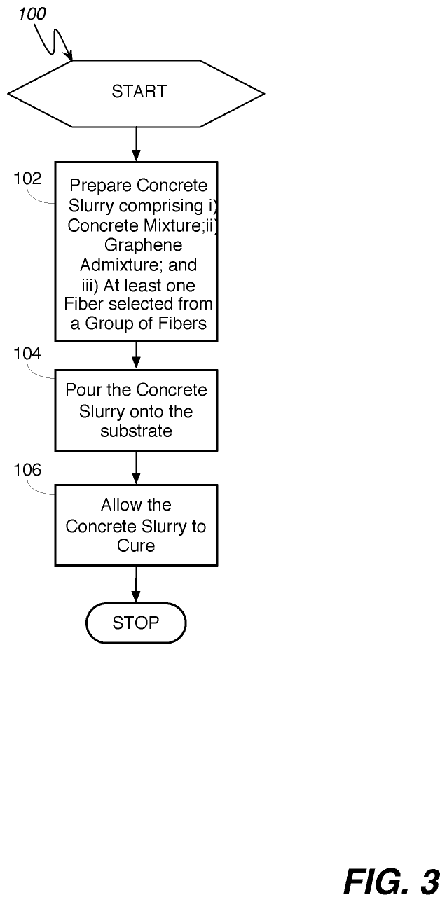

FIG. 3 is a flow diagram of a first illustrative method 100 according to an exemplary embodiment. Method 100 discloses steps, not all of which are necessarily employed in each and every situation, but which may have similarities to other exemplary embodiments provided herein. The steps in method 100 may be performed in or out of the order shown. Method 100 comprises the steps of: preparing a concrete slurry comprising i) a concrete mixture; ii) a graphene admixture; and iii) at least one fiber selected from a group consisting of fibers selected from steel fibers and synthetic fibers (102); pouring the concrete slurry onto the substrate (104) and allowing the concrete structure to be embedded with nanometer-sized graphene as the concrete cures (106).

In some exemplary embodiments, preparing step 102 of method 100 comprises preparing the concrete slurry with graphene that is in an aqueous solution and that comprises graphene having a size ranging from between about 1.10±0.20 nm of thickness with size of about 0.5 nm. In another embodiment, preparing step 102 additionally comprises adding the graphene, via a composite admixture with other additives, or an independent graphene admixture, to the concrete slurry in ranges of between about 0.01% to about 0.10% by weight of cement, wherein % by weight in this instance refers to the aggregate weight of the graphene in comparison to the final weight of cement in the final concrete product. In another embodiment, preparing step 102 additionally comprises preparing the concrete slurry for pouring with dosages of steel fibers as the at least one fiber selected from a group of fibers of between about 33.0 lbs./cuyd to about 66.0 lbs./cuyd. In another embodiment, preparing step 102 additionally comprises preparing the concrete admixture for pouring with dosages of macro synthetic fibers as the at least one fiber selected from a group of fibers of between about 3.0 lbs./cuyd to about 7.5 lbs./cuyd.

FIG. 4 is a flow diagram of a second illustrative method 200 according to an exemplary embodiment. Some of the steps of method 200 are identical to the steps in method 100 of FIG. 3; therefore, only the differences in method 200 are detailed herein. Method 200 additionally comprises the step 108 of spray-applying a secondary graphene application/primary graphene application onto the poured concrete slurry to facilitate curing thereof. Spray-applying step 108 comprises spray applying the secondary graphene application/primary graphene application (of a different type not already in the concrete) onto the poured concrete slurry while the concrete slurry is wet and/or subsequent to removal of a trowel machine and prior to cement in the poured concrete slurry being completely set.

Spray-applying step 108 may comprise, in other embodiments, spray-applying the poured concrete slurry with a graphene in an aqueous solution having dispersed particles with size of about 5.0 nm, wherein the mixture used for the spray-applying has between about 10.0 grams to 1,000.0 grams of graphene per gallon of carrier, and wherein the coverage rate is about 250 gallons of graphene solution per square foot, or from about 100.0 to about 500.0 gallons per square foot. Spray-applying step 108 also may comprise spray-applying the secondary graphene application/primary graphene application (of a different type, for example) onto the poured concrete slurry subsequent to cement in the poured concrete slurry being completely set, and spray-applying to the point of saturation or “flooding state” as is known in the art.

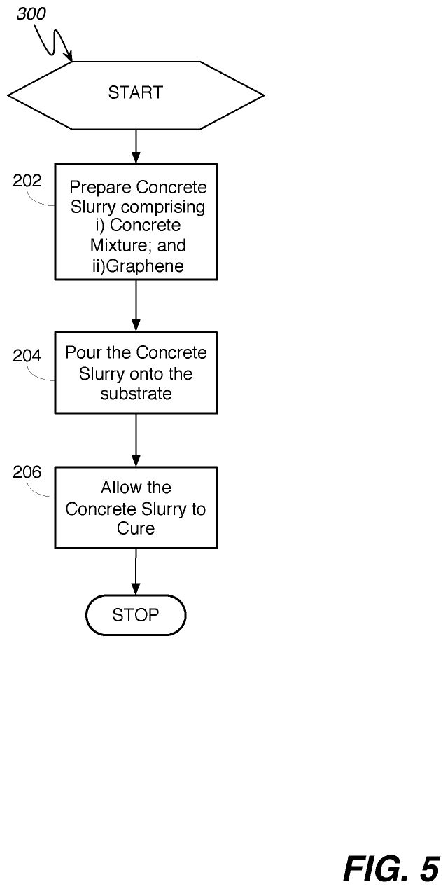

FIG. 5 is a flow diagram of a third illustrative method 300 according to an exemplary embodiment. In an exemplary embodiment method 300 comprises the steps of: preparing a concrete slurry comprising i) a concrete mixture and ii) a graphene admixture (202); pouring the concrete slurry onto the substrate (204); and allowing the concrete slurry to cure (206), such that the concrete structure defining the capillary structures is embedded with nanometer-sized graphene.

In some exemplary embodiments, similar to those described for FIG. 3 and FIG. 4, the preparing step 202 of method 300 comprises: (1) preparing a graphene admixture comprising the steps of (i) adding graphite powder to a solvent or liquid carrier, and (ii) either mechanically shearing the combination with a high-shear mixing device, such that the graphene yielded from the sheared graphite powder are dispersed into the solvent or liquid carrier, and/or mechanically shearing the graphite powder via probe sonication with an ultrasonic cavitation device, such that the produced graphene are dispersed into solution; and (2) preparing the concrete slurry with the graphene admixture as prepared, which comprises graphene having a size ranging from between about 1.10+/−0.20 nm of thickness with particle size of about 0.5 nm. In another embodiment, preparing step 202 additionally comprises adding the graphene to the concrete slurry in ranges of between about 0.01% to about 0.10% by weight of cement.

In some exemplary embodiments, preparing step 202 of method 300 comprises preparing a graphene admixture comprising the steps of (i) adding graphite powder to a solvent or liquid carrier, (ii) adding a polycarboxylate additive, and (iii) either mechanically shearing the combination with a high-shear mixing device, and/or mechanically shearing the combination via probe sonication with an ultrasonic cavitation device.

FIG. 6 is a flow diagram of a fourth illustrative method 400 according to an exemplary embodiment. Some of the steps of method 400 are identical to steps in method 300 of FIG. 5; therefore, only the differences in method 400 are detailed herein. Method 400 additionally comprises the step 208 of spray-applying a secondary graphene application/primary graphene application onto the poured concrete slurry to facilitate curing thereof. Spray-applying step 208 comprises spray applying the secondary graphene/primary graphene application onto the poured concrete slurry subsequent to removal of a trowel machine and prior to cement in the poured concrete slurry being completely set. Spray-applying step 208 comprises spray applying the poured concrete slurry with graphene in an aqueous solution having dispersed particles with size of about 5.0 nm, wherein the aqueous solution has between about 10.0 grams to 1,000.0 grams of graphene per gallon of liquid carrier. Spray-applying step 208 also comprises spray-applying the secondary graphene application/primary graphene application onto the poured concrete slurry subsequent to cement in the poured concrete slurry being completely set.

Spray-applying step 208 may comprise, in other embodiments, spray-applying the poured concrete slurry with a graphene in an aqueous solution, without spray-applying colloidal silica, and having dispersed particles with size of about 5.0 nm, wherein the graphene solution has a particle weight that ranges from between about 0.01% to about 0.10%, and wherein the coverage rate is about 250 gallons of graphene solution per square foot, or from about 100.0 to about 500.0 gallons per square foot.

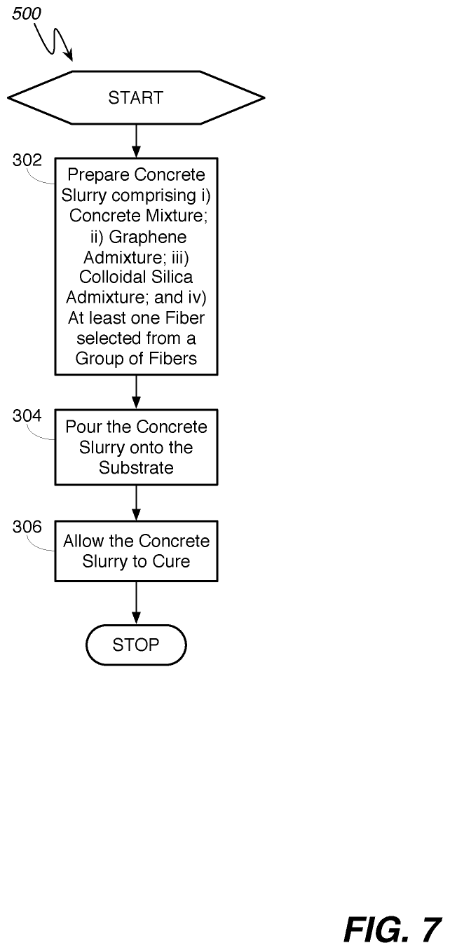

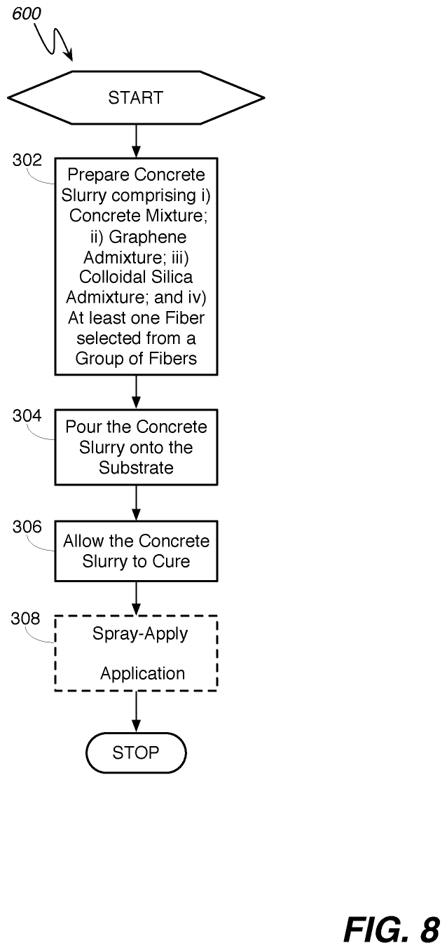

FIG. 7 is a flow diagram of a fifth illustrative method 500 according to an exemplary embodiment. Method 500 discloses steps, not all of which are necessarily employed in each and every situation, but which may have similarities to other exemplary embodiments provided herein. The steps in method 500 may be performed in or out of the order shown. Method 500 comprises the steps of: (1) preparing a concrete slurry comprising i) a concrete mixture; ii) a graphene admixture; iii) a colloidal silica admixture; and iv) at least one fiber selected from a group consisting of fibers selected from steel fibers and synthetic fibers (302); (2) pouring the concrete slurry onto the substrate (304); and (3) allowing the concrete slurry to cure (306). Method 500 allows the capillary structures to develop as the concrete slab sets from the poured concrete slurry, allows the capillary structures of the slab to at least in part fill with silica and lime, allows the silica and lime to react to produce a gel structure of calcium silicate hydrate that at least partially fill, respectively, the capillary structures, and allows the concrete structure defining the capillary structures to be embedded with nanometer-sized graphene.

In some exemplary embodiments, preparing step 302 of method 500 comprises: (1) preparing a graphene and colloidal silica composite admixture comprising the steps of (i) adding graphite powder to a prepared colloidal silica admixture, and (ii) mechanically shearing the combination with a high-shear mixing device such that the produced graphene are dispersed into the colloidal silica admixture; and (2) preparing the concrete slurry with the colloidal silica and graphene composite admixture, which comprises silica having a size ranging from between about 10.0 nm to about 100.0 nm, or from between about 5.0 nm to about 100.0 nm, or from between about 3.0 nm to about 100.0 nm, and graphene having a size ranging from between about 1.10±0.20 nm of thickness with particle size of about 0.5 nm.

In another exemplary embodiment, preparing step 302 comprises providing a prepared colloidal silica admixture, and preparing a graphene admixture that is independent from the prepared colloidal silica admixture. The admixtures then may be independently, but not necessarily separately, used to prepare the concrete slurry. In another exemplary embodiment, preparing step 302 comprises preparing the graphene and colloidal silica admixture(s) comprising the steps of adding graphite powder to an aqueous solution and mechanically shearing the graphite powder via probe sonication with an ultrasonic cavitation device such that the produced graphene are dispersed into solution.

In another embodiment, preparing step 302 additionally comprises adding the colloidal silica admixture to the concrete slurry in ranges of between about 0.50% to about 10.0% by weight of cement in the concrete mixture, wherein % by weight refers to the aggregate weight of the silica in comparison to the final weight of cement in the final concrete product. In another exemplary embodiment, preparing step 302 comprises adding the graphene, via a composite admixture or an independent graphene admixture, to the concrete slurry in ranges of between about 0.01% to about 0.10% by weight of cement, wherein % by weight in this instance refers to the aggregate weight of the graphene in comparison to the final weight of cement in the final concrete product. In another embodiment, preparing step 302 additionally comprises preparing the concrete slurry for pouring with dosages of steel fibers as the at least one fiber selected from a group of fibers of between about 33.0 lbs./cuyd to about 66.0 lbs./cuyd. In another embodiment, preparing step 302 additionally comprises preparing the concrete admixture for pouring with dosages of macro synthetic fibers as the at least one fiber selected from a group of fibers of between about 3.0 lbs./cuyd to about 7.5 lbs./cuyd.

FIG. 8 is a flow diagram of a sixth illustrative method 600 according to an exemplary embodiment. Some of the steps of the method 600 are identical to the steps in method 500 of FIG. 7; therefore, only the differences in method 600 are detailed herein. Method 600 additionally comprises the step 308 of spray-applying a secondary colloidal silica onto the poured concrete slurry to facilitate curing thereof. Spray-applying step 308 comprises spray applying the secondary colloidal silica onto the poured concrete slurry subsequent to removal of a trowel machine and prior to cement in the poured concrete slurry being completely set. Spray-applying step 308 may comprise in other embodiments spray-applying the poured concrete slurry with an amorphous secondary colloidal silica in an aqueous solution having silica with size ranging from about 10.0 nm to about 50.0 nm, or from about 3.0 nm to about 50.0 nm, or from about 3.0 nm to about 25.0 nm, or from about 3.0 nm to about 100.0 nm wherein the colloidal solution used for the spray-applying has between about 10.0 grams to 1,000.0 grams of colloidal silica per gallon of colloid, and wherein the coverage rate is about 250 gallons of colloidal solution per square foot, or from about 100.0 to about 500.0 gallons per square foot. Spray-applying step 308 also may comprise spray-applying the secondary colloidal silica onto the poured concrete slurry subsequent to cement in the poured concrete slurry being completely set, and spray-applying to the point of saturation or “flooding state” as is known in the art.

In some exemplary embodiments, step 308 of method 600 comprises spray-applying a graphene and colloidal silica composite admixture similar to the composite admixture defined herein for certain embodiments of step 302. In another exemplary embodiment, step 308 of method 600 comprises spray-applying a prepared colloidal silica admixture and a graphene admixture prepared at the point-of-use and that is independent from the prepared colloidal silica admixture, those admixtures as defined herein for certain embodiments of step 302.

Spray-applying step 308 may comprise, in other embodiments, spray-applying the poured concrete slurry with a graphene in an aqueous solution, without spray-applying colloidal silica, and having dispersed particles with size of about 5.0 nm, wherein the colloidal solution used for the spray-applying has between about 10.0 grams to 1,000.0 grams of graphene per gallon of colloid, and wherein the coverage rate is about 250 gallons of graphene solution per square foot, or from about 100.0 to about 500.0 gallons per square foot.

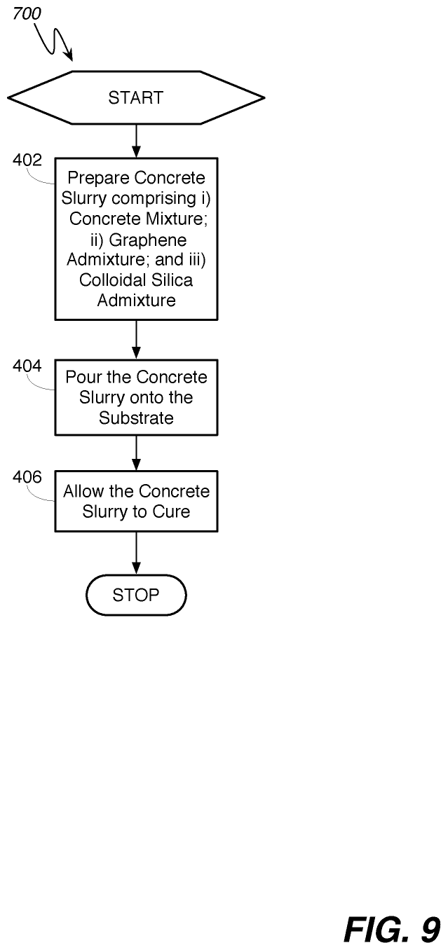

FIG. 9 is a flow diagram of a seventh illustrative method 700 according to an exemplary embodiment. In an exemplary embodiment method 700 comprises the steps of: preparing a concrete slurry comprising i) a concrete mixture; ii) a graphene admixture; and iii) a colloidal silica admixture (402); pouring the concrete slurry onto the substrate (404); and allowing the concrete slurry to cure (406).

In some exemplary embodiments, similar to those described for FIG. 7 and FIG. 8, preparing step 402 of method 700 comprises: (1) preparing a graphene and colloidal silica composite admixture comprising the steps of (i) adding graphite powder to a prepared colloidal silica admixture, and (ii) either mechanically shearing the combination with a high-shear mixing device, such that the produced graphene are dispersed into the colloidal silica admixture, and/or mechanically shearing the graphite powder via probe sonication with an ultrasonic cavitation device, such that the produced graphene are dispersed into solution; and (2) preparing the concrete slurry with the colloidal silica and graphene composite admixture, which comprises silica having a size ranging from between about 10.0 nm to about 100.0 nm, or from between about 5.0 nm to about 100.0 nm, or from between about 3.0 nm to about 100.0 nm, and graphene having a size ranging from between about 1.10+/−0.20 nm of thickness with size of about 0.5 nm. In another exemplary embodiment, the preparing step 402 comprises providing a prepared colloidal silica admixture, and preparing a graphene admixture that is independent from the prepared colloidal silica admixture. The admixtures may then be independently, but not necessarily separately, used to prepare the concrete slurry.

In another embodiment, preparing step 402 additionally comprises adding the colloidal silica admixture to the concrete slurry in ranges of between about 0.50% to about 10.0% by weight of cement in the concrete mixture. In another exemplary embodiment, preparing step 402 comprises adding the graphene, via a composite admixture or an independent graphene admixture, to the concrete slurry in ranges of between about 0.01% to about 0.10% by weight of cement.

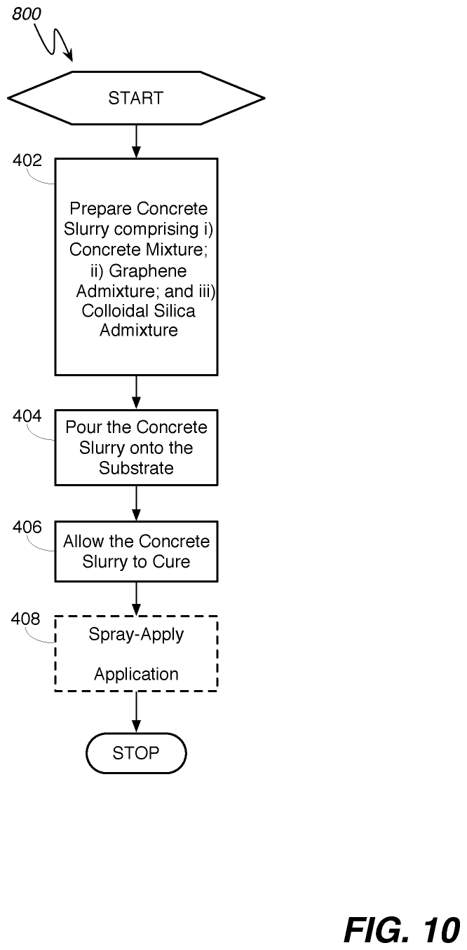

FIG. 10 is a flow diagram of an eighth illustrative method 800 according to an exemplary embodiment. Some of the steps of method 800 are identical to steps in method 700 of FIG. 9; therefore, only the differences in method 800 are detailed herein. Method 800 additionally comprises the step 408 of spray-applying a secondary colloidal silica onto the poured concrete slurry to facilitate curing thereof. Spray-applying step 408 comprises spray applying the secondary colloidal silica onto the poured concrete slurry subsequent to removal of a trowel machine and prior to cement in the poured concrete slurry being completely set. Spray-applying step 408 comprises spray-applying the poured concrete slurry with an amorphous secondary colloidal silica in an aqueous solution having silica with size ranging from about 10.0 nm to about 50.0 nm, or from about 3.0 nm to about 50.0 nm. Spray-applying step 408 comprises spray-applying the secondary colloidal silica onto the poured concrete slurry subsequent to cement in the poured concrete slurry being completely set.

In some exemplary embodiments, step 408 of method 800 comprises spray-applying a graphene and colloidal silica composite admixture similar to the composite admixture defined herein for certain embodiments of step 402. In another exemplary embodiment, step 408 of method 800 comprises spray-applying a prepared colloidal silica admixture and a graphene admixture prepared at the point-of-use and that is independent from the prepared colloidal silica admixture, those admixtures as defined herein for certain embodiments of step 402.

Spray-applying step 408 may comprise, in other embodiments, spray-applying the poured concrete slurry with a graphene in an aqueous solution, without spray-applying colloidal silica, and having dispersed particles with size of about 5.0 nm, wherein the aqueous solution has between about 10.0 grams to 1,000.0 grams of graphene per gallon of solution, and wherein the coverage rate is about 250 gallons of graphene solution per square foot, or from about 100.0 to about 500.0 gallons per square foot.

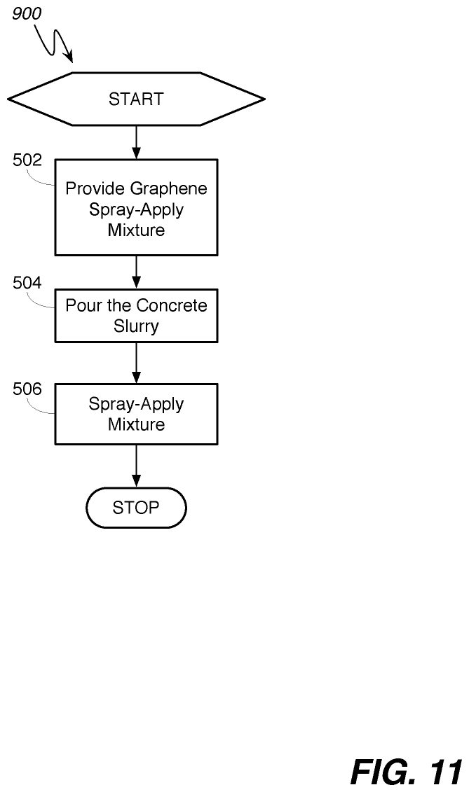

FIG. 11 is a flow diagram of a ninth illustrative method 900 according to an exemplary embodiment. Method 900 discloses steps, not all of which are necessarily employed in each and every situation, but which may have similarities to other exemplary embodiments provided herein. The steps in method 900 may be performed in or out of the order shown. Method 900 comprises the steps of: providing a graphene spray-apply mixture (502); pouring a concrete slurry onto a substrate or for a concrete product (504); and spray-applying the graphene spray-apply mixture onto the poured concrete slurry to facilitate curing thereof (506). This allows the concrete structure to be embedded with nanometer-sized graphene as the concrete cures.

In some exemplary embodiments, providing step 502 of method 900 comprises preparing a graphene spray-apply mixture similar to the graphene admixture defined herein for certain embodiments of step 102 for method 100, for example. In another exemplary embodiment, step 502 of method 900 comprises spray applying a graphene spray-apply mixture prepared at the point-of-use and that is independent from any prepared colloidal silica admixture or mixture that may or may not be used.

In some exemplary embodiments, spray-applying step 506 comprises spray-applying the graphene spray-apply mixture onto the poured concrete slurry while the cement is in a wet state, immediately after pouring or some time thereafter. Spray-applying step 506 also may comprise spray-applying the graphene spray-apply mixture subsequent to removal of a trowel machine and prior to cement in the poured concrete slurry being completely set. Spray-applying step 506 also may comprise spray-applying the graphene spray-apply mixture onto the poured concrete slurry subsequent to cement in the poured concrete slurry being completely set, and spray-applying to the point of saturation or “flooding state” as is known in the art.

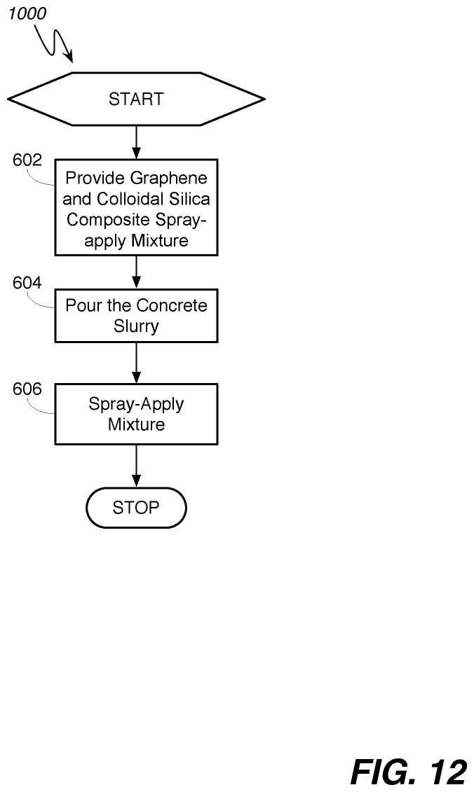

FIG. 12 is a flow diagram of a tenth illustrative method 1000 according to an exemplary embodiment. Method 1000 discloses steps, not all of which are necessarily employed in each and every situation, but which may have similarities to other exemplary embodiments provided herein. The steps in method 1000 may be performed in or out of the order shown. Method 1000 comprises the steps of: providing a graphene and colloidal silica composite spray-apply mixture (602); pouring a concrete slurry onto a substrate or for a concrete product (604); and spray-applying the graphene and colloidal silica composite spray-apply mixture onto the poured concrete slurry to facilitate curing thereof (606). This allows the concrete structure to be embedded with nanometer-sized graphene, and colloidal silica and lime reactant product, as the concrete cures.

In some exemplary embodiments, providing step 602 of method 1000 comprises preparing a graphene and colloidal silica composite spray-apply mixture similar to the graphene admixture and colloidal silica admixture defined herein for certain embodiments of step 102 of method 100 and step 302 of method 500, for example, or wherein the composite mixture has between about 10.0 grams to 1,000.0 grams of graphene or colloidal silica per gallon of mixture. In another exemplary embodiment, step 602 of method 1000 comprises spray-applying a graphene and colloidal silica composite spray-apply mixture prepared at the point-of-use and that is independent from any prepared colloidal silica admixture or mixture or graphene admixture or mixture that may or may not be used.

In some exemplary embodiments, spray-applying step 606 comprises spray-applying the composite spray-apply mixture onto the poured concrete slurry while the cement is in a wet state, immediately after pouring or some time thereafter. Spray-applying step 606 also may comprise spray-applying the composite spray-apply mixture onto the poured concrete slurry subsequent to removal of a trowel machine and prior to cement in the poured concrete slurry being completely set. Spray-applying step 606 also may comprise spray-applying the graphene and colloidal silica composite spray-apply mixture onto the poured concrete slurry subsequent to cement in the poured concrete slurry being completely set, and spray-applying to the point of saturation or “flooding state” as is known in the art.

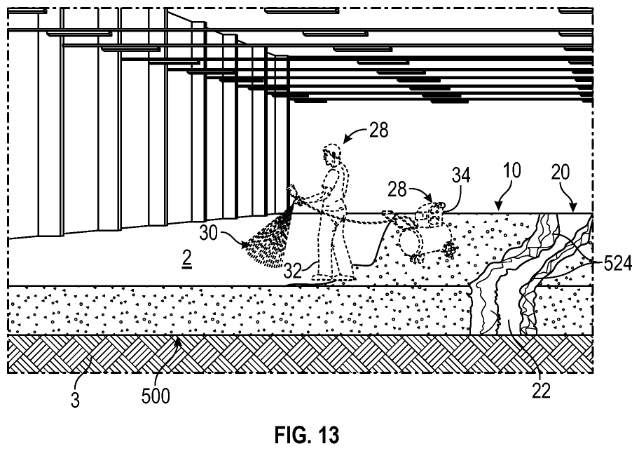

FIG. 13 shows a perspective view of an exemplary fiberless concrete slab 500. Fiberless concrete slab 500 is similar to concrete slab 1 of FIG. 1; therefore, only the differences in fiberless concrete slab 500 are detailed herein.

Fiberless concrete slab 500 is illustrated in partial cut-away form to show layers of internal composition and structure of the composite material. Second cut-away section 20 illustrates fiberless concrete slab 500 having a crack 22 to expose the internal composition of the composite material of fiberless concrete slab 500. In particular, fiberless concrete slab 500 comprises hardened aggregate and cement 524 without steel fibers and/or macro synthetic fibers. Hardened aggregate and cement 524 at least in part define capillary structures 26 (FIG. 2) throughout fiberless concrete slab 500, and capillary structures 26 (FIG. 2) are filled with reactive nanometer-sized silica that react with free lime to produce a stable gel structure of calcium silicate hydrate within the capillary structures 26 (FIG. 2). Hardened aggregate and cement 524 defining capillary structures 26 is embedded with nanometer-sized graphene. An optional spray-apply system 28 may be used for spray-applying a secondary colloidal silica and dispersed graphene composite 30 on the entire surface of fiberless concrete slab 500 to saturation such that the nanometer-sized colloidal silica in secondary spray 30 can penetrate and complete the fill of capillary structures 26, and such that the graphene can be dispersed to embed along and partially fill capillary structures 26 throughout hardened aggregate and cement 524.

A wide variety of materials are available for the various parts discussed and illustrated herein. Although the device has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A concrete product set by pouring a concrete slurry, the poured concrete slurry comprising:
a) a concrete mixture;
b) a graphene admixture; and
c) at least one fiber selected from the group of fibers consisting of steel fibers, helix fibers, basalt fibers, polyvinyl alcohol (PVA) fibers, carbon fibers, and synthetic fibers;
wherein, as the poured concrete slurry cures, the poured slurry hardens into a composite material, the composite material defining capillary structures that at least in part fill with graphene; and
wherein the graphene embed along and partially fill the capillary structures; whereby the embedded graphene at least in part distribute the load of the composite material acting on the concrete product.

2. The concrete product of claim 1 wherein the concrete product is set by pouring the concrete slurry and then applying a curing technique to the poured concrete slurry, and wherein the curing technique comprises spray-applying a secondary graphene onto the poured concrete slurry.

3. The concrete product of claim 2 wherein the graphene also is spray-applied onto the poured concrete slurry subsequent to removing a trowel machine.

4. The concrete product of claim 2 wherein the graphene of the secondary graphene application are about 1.10±0.20 nm thick with lattice constant of about 0.27 nm×0.41 nm.

5. The concrete product of claim 2 wherein the graphene is spray-applied onto the poured concrete slurry subsequent to cement in the poured concrete slurry being set.

6. The concrete product of claim 1 wherein the concrete mixture comprises aggregate, cement, and water, and wherein the concrete mixture is defined by a water to cement ratio of between about 0.400 to about 0.450.

7. The concrete product of claim 1 wherein the at least one fiber selected from the group consisting of steel fibers, helix fibers, basalt fibers, PVA fibers, carbon fibers, and synthetic fibers represents between about 0.20% by volume to about 0.50% by volume of the poured concrete slurry.

8. A process for preparing a concrete product, the process comprising:
a) preparing a concrete slurry, the concrete slurry comprising:
i) a concrete mixture;
ii) a graphene admixture; and
iii) at least one fiber selected from the group of fibers consisting of steel fibers, helix fibers, basalt fibers, PVA fibers, carbon fibers, and synthetic fibers;
b) pouring the concrete slurry; and
c) allowing the concrete slurry to cure such that capillary structures develop as the concrete product sets from the poured concrete slurry, and such that the capillary structures of the product at least in part fill with graphene, and such that the graphene embed along and partially fill the capillary structures.

9. The process for preparing a concrete product of claim 8 wherein the preparing step comprises preparing the concrete slurry with graphene having a size of about 1.10±0.20 nm thick with lattice constant of about 0.27 nm×0.41 nm.

10. The process for preparing a concrete product of claim 9 wherein the preparing step additionally comprises adding the graphene admixture to the concrete slurry in ranges of between about 0.01% to about 0.10% by weight of cement.

11. The process for preparing a concrete product of claim 9 wherein the preparing step additionally comprises adding the graphene admixture to the concrete slurry in ranges of between about 0.01% to about 0.10% by weight of cement.

12. The process for preparing a concrete product of claim 8 additionally comprising the step of spray-applying a secondary graphene onto the poured concrete slurry to facilitate curing thereof.

13. The process for preparing a concrete product of claim 12 wherein the spray-applying step comprises spray-applying the secondary graphene onto the poured concrete slurry subsequent to removal of a trowel machine and prior to cement in the poured concrete slurry being completely set.

14. The process for preparing a concrete product of claim 12 wherein the spray-applying step comprises spray-applying the poured concrete slurry with a secondary graphene application having graphene with size of about 1.10±0.20 nm thick with lattice constant of about 0.27 nm×0.41 nm.

15. The process for preparing a concrete product of claim 12 wherein the spray-applying step comprises spray-applying the secondary graphene onto the poured concrete slurry subsequent to cement in the poured concrete slurry being set.

16. The process for preparing a concrete product of claim 8 wherein the preparing step comprises preparing the concrete slurry for pouring with dosages of steel fibers as the at least one fiber selected from the group of fibers of between about 33.0 pounds per cubic yard (lbs./cuyd) to about 66.0 lbs./cuyd.

17. The process for preparing a concrete product of claim 8 wherein the preparing step comprises preparing the concrete slurry for pouring with dosages of helix fibers, basalt fibers, PVA fibers, or carbon fibers, as the at least one fiber selected from the group of fibers, of between about 3.0 lbs./cuyd to about 7.5 lbs./cuyd, or about 3.0 lbs./cuyd to about 35.0 lbs./cuyd if helix fibers.

18. A concrete product set from a poured concrete slurry, the poured concrete slurry comprising a concrete mixture, graphene admixture, and at least one fiber selected from the group of fibers consisting of steel fibers, helix fibers, basalt fibers, PVA fibers, carbon fibers, and synthetic fibers, the concrete product comprising capillary structures that are at least in part embedded with and filled with graphene, the embedded graphene being graphene monolayers or overlapping graphene layers, whereby the embedded graphene monolayers or overlapping graphene layers at least in part distribute the load acting on the concrete product.

19. The concrete product of claim 18 wherein the graphene are about 1.10±0.20 nm thick with lattice constant of about 0.27 nm×0.41 nm.

20. The concrete product of claim 18 wherein the concrete product is cured by application of a spray-applied secondary graphene oxide.

21. The concrete product of claim 20 wherein the graphene have a size of about 1.10±0.20 nm thick with lattice constant of about 0.27 nm×0.41 nm.

22. The concrete product of claim 18 wherein the concrete mixture comprises aggregate, cement, and water, and wherein the concrete mixture is defined by a water to cement ratio of between about 0.400 to about 0.450.

23. The concrete product of claim 18 wherein the at least one fiber selected from the group consisting of steel fibers, helix fibers, basalt fibers, PVA fibers, carbon fibers, and synthetic fibers represents between about 0.20% by volume to about 0.50% by volume of the poured concrete slurry.
